(19) United States
(12) Patent Application Publication
(10) Pub. No.: US 2008/0138034 A1
(43) Pub. Date: Jun. 12, 2008

(54) PLAYER FOR MOVIE CONTENTS

(76) Inventors: Kazushige Hiroi, Machida (JP); Riri Ueda, Ebina (JP); Norikazu Sasaki, Ebina (JP); Nobuhiro Sekimoto, Yokohama (JP); Masahiro Kato, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/759,265

(22) Filed: Jun. 7, 2007

(30) Foreign Application Priority Data
Dec. 12, 2006 (JP) 2006-333952

(51) Int. Cl. H04N 5/91

(52) U.S. Cl. 386/95

(57) ABSTRACT

In the present apparatus, keywords contained in a selected movie contents data are indicated, for example, for selection by a user so that the user can view a desirable scene designated by the user. The apparatus includes, for example, a keyword displaying unit for displaying, on plural windows, plural keywords corresponding to a movie contents data, a selection input unit for receiving a selection input of a first keyword selected from the plural keywords displayed by the keyword displaying unit, and a scene playback unit for playing back one or more scenes corresponding to the selected first keyword.

### INCORPORATION BY REFERENCE

The present application claims priority from Japanese application JP2006-333952 filed on Dec. 12, 2006, the content of which is hereby incorporated by reference into this application.

### BACKGROUND OF THE INVENTION

The present invention relates to apparatus for playing back movie contents data, and particularly to techniques for extracting, selecting and playing back specified scenes in a movie contents data.

Techniques for extracting specified scenes from a movie contents data have been known, for example, from JP-A-2003-153,139 (Patent Document 1), JP-A-2006-115,052 (Patent Document 2) and “Video Summarization by Curve Simplification” by D. DeMenthon, V. Kobla and D. Doermann, ACM Multimedia 98, Bristol, England, pp. 211-218, 1998 (Non-patent Document 1).

Patent Document 1 describes that: “A degree of non-significance for a moving image is applied for each scene of the image by using an input means. A non-significance degree extracting means acquires a moving image to be watched from a storage means, finds the degree of non-significance applied for each scene of the moving image and outputs this degree to a reproduction control means. The reproduction control means fast forwards the scene added with the degree of non-significance and records a time t1, when the scene is not non-significant and at a time t2, when the scene becomes non-significant again, a moving image reproducing means is instructed to reproduce moving images from the time t1 to the time t2. The moving image reproducing means reproduces the moving images from the time t1 to the time t2 on a display means.”

Non-patent Document 1 describes that: “This paper describes a system for automated performance evaluation of video summarization algorithms. We call it SUPERSIEV (System for Unsupervised Performance Evaluation of Ranked Summarization in Extended Videos). It is primarily designed for evaluating video summarization algorithms that perform frame ranking. The task of summarization is viewed as a kind of database retrieval, and we adopt some of the concepts developed for performance evaluation of retrieval in database systems. First, ground truth summaries are gathered in a user study from many assessors and for several video sequences. For each video sequence, these summaries are combined to generate a single reference file that represents the majority of assessors' opinions. Then the system determines the best target reference frame for each frame of the whole video sequence and computes matching scores to form a lookup table that rates each frame. Given a summary from a candidate summarization algorithm, the system can then evaluate this summary from different aspects by computing recall, cumulated average precision, redundancy rate and average closeness. With this evaluation system, we can not only grade the quality of a video summary, but also (1) compare different automatic summarization algorithms and (2) make stepwise improvements on algorithms, without the need for new user feedback.”

Patent Document 2 describes it as a problem “To search recorded contents easily and efficiently” and further describes as means for solving the problem that: “The content search device stores a content decoded through a tuner section 6 in a content storage section 5. The stored content and subtitle information incident to that content are analyzed at a subtitle analyzing section 8, and the content is divided into predetermined units and imparted with a retrieval index using subtitle information. When a retrieval key consisting of a word transmitted from the input unit is received at the receiving section 1 of the content search device, a retrieval section 2 retrieves the content stored in the content storage section 5 using the received word as a retrieval query. Retrieval results are transferred from a transmitting section 3 to a display 4”

### SUMMARY OF THE INVENTION

Recently, it has been become possible to get or view many movie contents data owing to the broadcasting of the movie contents data on a larger number of channels in the digital television broadcasting service and use of broader bandwidth in the networking. Further, improvements in the movie contents data compression and expantion techniques, a lowering of the cost of the hardware/software for implementing the improved movie contents compression and expansion techniques and an increase of the capacity of and a lowering of the cost of storage media allow easy saving of many movie contents data with a result that movie contents data available for viewing is increasing.

However, many busy people do not have enough time to view the whole of the available movie contents data, allowing the rest of the movie contents data unviewed to overflow. Thus, it is conceived, for example, that techniques for extracting specified scenes in a movie contents data will be indispensable.

In this respect, according to the measures of Patent Document 1 and Non-patent Document 1, it will be possible for a user to grasp the substance or content of a movie contents data within a short time. However, in these measures, it is an apparatus that will determine and extract a specified scene in a movie contents data, which may result in that the thus determined and extracted specified scene does not conform to a scene the user intended to view.

In Patent Document 2, when a user first inputs a keyword through a camera or the like, contents corresponding to a keyword are retrieved among plural contents (movie contents data) recorded. However, a user himself or herself may intend to first select a movie contents data (a content) to extract a specified scene from the selected movie contents data. In that case, without viewing the selected movie contents data in advance, the user will not be able to know what keywords are contained in the selected movie contents data, which leads to the fact that the user, first of all, cannot input any keyword. Namely, the measures according to this document may not be satisfactory in a case in which a user selects a movie contents data, which the user has not viewed yet, to view user's interesting scenes within the selected movie contents data in a short time.

An object of the present invention is to provide an apparatus which displays keywords contained in a selected move contents data for selection by a user.

According to one aspect of the present invention, there is provided a player for movie contents having a keyword displaying unit for displaying, on a plurality of display windows, a plurality of keywords corresponding to a movie contents data, a selection input receiving unit for receiving a selection input for selecting a first keyword among the plurality of keywords displayed by the keyword displaying unit, and a scene playback unit for playing back one or more scenes corresponding to the first keyword.

According to another aspect of the present invention, there is provided a player for movie contents having the units described in connection with the first-mentioned aspect and further having a scene position displaying unit for displaying a position or a time, in the movie contents data, of the one or more scenes corresponding to the first keyword, in association with the corresponding first keyword.

According to the movie contents player, a user is allowed to efficiently view a specified scene or scenes in a movie contents data.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram of an example of a hardware structure in which function blocks of a player for movie contents are implemented by a software.

FIG. 2 is a block diagram of an example of function blocks of a player for movie contents according to Embodiment 1.

FIG. 3 is a diagram showing an example of a data structure of an indexing data.

FIG. 4 is a diagram showing an example of a data structure of a keyword data.

FIG. 5A is a diagram showing an example of a display screen in a player for movie contents.

FIG. 5B is a diagram showing another example of a display screen in a player for movie contents.

FIG. 5C is a diagram showing another example of a display screen in a player for movie contents.

FIG. 5D is a diagram showing another example of a display screen in a player for movie contents.

FIG. 5E is a diagram showing another example of a display screen in a player for movie contents.

FIG. 6 is a diagram showing an example of a data structure of a keyword position data.

FIG. 7 is a diagram showing an example of an indication of a keyword position.

FIG. 8 is a flowchart illustrating an example of processing in the reproducing control unit.

FIG. 9 is a flowchart illustrating an example of an operation in which a movie contents data is recorded.

FIG. 10 is a flowchart illustrating an example of an operation in which a movie contents data is played back.

FIG. 11 is a block diagram of an example of function blocks of a player for movie contents according to Embodiment 2.

FIG. 12 is a block diagram of an example of function blocks of a player for movie contents according to Embodiment 3.

FIG. 13 is a block diagram of an example of function blocks of a player for movie contents according to Embodiment 4.

FIG. 14 is a diagram showing an example of a display window on which a keyword is inputted in the form of characters.

### DESCRIPTION OF THE EMBODIMENTS

Preferred embodiments will now be described with reference to the accompanying drawings.

### Embodiment 1

### (1) Hardware Structure

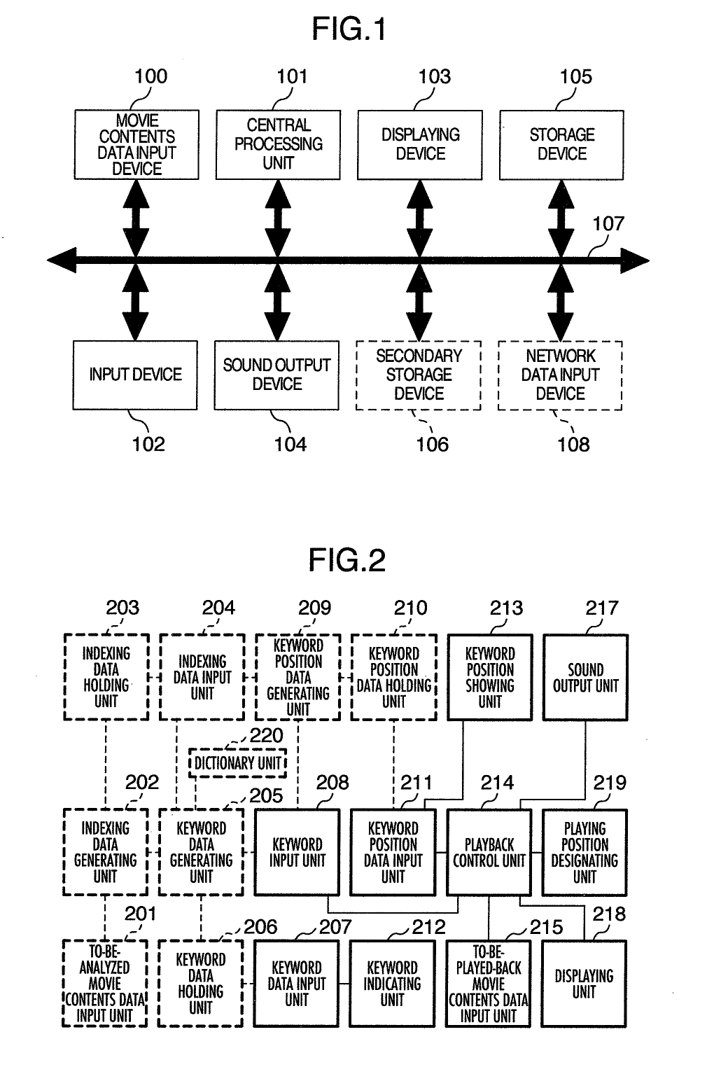

FIG. 1 is a diagram of an example of a hardware structure of a player for movie contents according to an embodiment of the present embodiment.

The player for movie contents may, for example, involve a harddisk recorder, a videotape recorder, a personal computer, a portable terminal and the like, which are capable of playing back movie contents data.

As shown in FIG. 1, a player for movie contents includes a movie contents data input device 100, a central processing unit 101, an input device 102, a displaying device 103, a sound output device 104, a storage device 105, a secondary storage device 106 and a network data input device 108. All of the devices are connected to one another through a bus 107 for data transmission and reception among them.

The movie contents data input device 100 inputs a movie contents data. The device 100 may be, for example, a device for reading movie contents data stored in the storage device 105 or in the secondary storage device 106 to be described later, or may be a tuner unit for a television receiver when a television broadcast is received. In the case in which a movie contents data is inputted via a network, the device 100 may be a network card such as a LAN card.

The central processing unit 101 mainly consists of a microprocessor and executes programs stored in the storage device 105 and the secondary storage device 106 to control the operation of the movie contents player.

The input device 102 is implemented, for example, with a pointing device such as a remote controller, a keyboard or a mouse, which allows a user to give instructions to the movie contents player.

The displaying device 103 may be implemented, for example, with a display adaptor and a liquid crystal panel or projector, on which played-back pictures or display windows to be described later are displayed.

The sound output device 104 is implemented, for example, with a sound card and a speaker, with which sound contained in played back movie contents data is outputted.

The storage device 105 may be implemented, for example, with a random access memory (RAM), in which programs to be executed by the central processing unit 101, data to be processed by the present movie contents player and/or movie contents data to be played back are stored.

The secondary storage device 106 may be implemented, for example, with a hard disk, a DVD or CD and a drive therefor, or a non-volatile memory such as a flash memory, in which programs to be executed by the central processing unit 101, data to be processed by the present movie contents player and/or movie contents data to be played back are stored. The secondary storage device 106 is not essential.

The network data input device 108 may be implemented, for example, with a network card such as a LAN card, which inputs movie contents data and/or information concerning movie contents data from another apparatus connected through a network. The network data input device 108 is not essential except in Embodiment 4 to be described later.

### (2) Function Blocks, Data Structures and Display Screens

FIG. 2 is a block diagram of an example of function blocks of a player for movie contents according to the present embodiment. Although it is assumed, for convenience sake of explanation, that all of those function blocks are implemented with software programs to be executed by the central processing unit 101, a portion or all of the function blocks may be implemented by means of hardware.

As shown in FIG. 2, the player for movie contents according to the present embodiment includes a to-be-analyzed movie contents data input unit 201, an indexing data generating unit 202, an indexing data holding unit 203, an indexing data input unit 204, a keyword data generating unit 205, a keyword data holding unit 206, a keyword data input unit 207, a keyword input unit 208, a keyword position data generating unit 209, a keyword position data holding unit 210, a keyword position data input unit 211, a keyword showing unit 212, a keyword position showing unit 213, a reproducing control unit 214, a to-be-played-back movie contents data input unit 215, a sound output unit 217, a displaying unit 218, and a playing position designating unit 219.

When indexing data need not be generated in the present movie contents player as in a case in which use is made of indexing data already prepared by another apparatus, for example, the to-be-analyzed movie contents data input unit 201, the indexing data generating unit 202 and the indexing data holding unit 203 will no longer be essential. Further, when keyword data need not be generated as in a case in which use is made of keyword data already prepared by another apparatus, for example, the keyword data generating unit 205 and the keyword data holding unit 206 will no longer be essential. Further, when keyword position data need not be generated as in a case in which use is made of keyword position data already prepared by another apparatus, for example, the keyword position data generating unit 209 and the keyword position data holding unit 210 will no longer be essential.

In FIG. 2, the to-be-analyzed movie contents data input unit 201 inputs, through the movie contents data input device 100, a movie contents data for which an indexing data (to be described later) is to be generated.

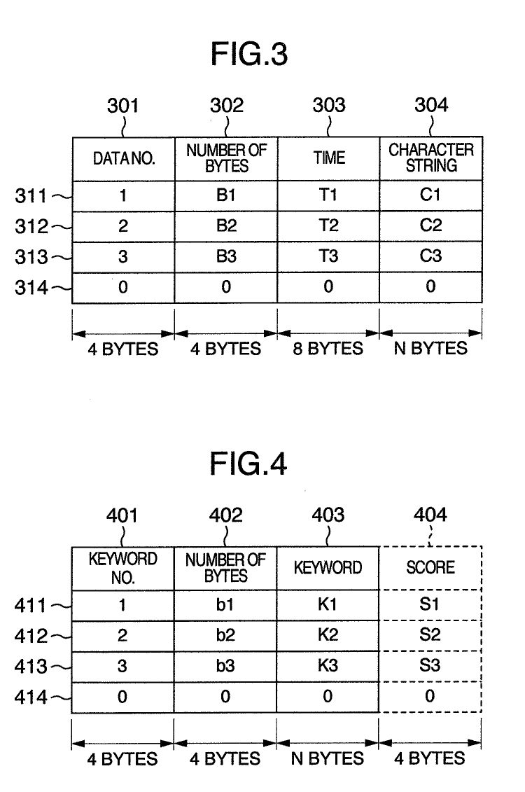

The indexing data generating unit 202 indexes an inputted movie contents data on the basis of a speech such as line or dialogue being spoken therein or a string of characters being displayed therein and a time at which the speech, such as line or dialogue, is spoken or a time at which the character string is displayed, and generates an indexing data to be described later with reference to FIG. 3.

For example, an indexing data as shown in FIG. 3 will be generated by obtaining caption data for a pronounced speech, such as line or dialogue being spoken and storing a character string for the caption along with time at which it is displayed. In the digital television broadcasting service, since elementary streams (ES) for the captions are transmitted in the same way as those for the sounds and videos, by decoding the ES's of the captions, it will be possible to obtain information on a character string to be displayed as a caption and information on a time at which it is to be displayed. Thus, it is possible to generate an indexing data as shown in FIG. 3.

Alternatively, for generation of an indexing data such as shown in FIG. 3, the indexing data generating unit 202 may perform speech recognition of the movie contents data inputted at the to-be-analyzed movie contents data input unit 201 thereby to generate a character string based on the recognized speech. The speech recognition can be achieved by applying a known technique, and description thereon will be omitted here. Results of the speech recognition may not necessarily be converted to character strings, but they may be in the form of features of phonemes or the like or the like. In that case, the features of phonemes may be stored in the character string storage area in FIG. 3.

Further, when the results of speech recognition are converted to those other than character strings, the keyword position data generating unit 209 may be adapted to have a structure such that a keyword appearing position is retrieved by use of phonemes or the like other than the character strings. This will be described later when reference is made to the keyword position data generating unit 209.

Alternatively, for generation of an indexing data such as shown in FIG. 3, the indexing data generating unit 202 may recognize a telop on the pictures of a movie contents data inputted at the to-be-analyzed movie contents data input unit 201 thereby to generate a character string based on the recognized telop. The telop recognition can be achieved by applying a known technique, and description thereon will be omitted here. Results of the telop recognition may not necessarily be converted to character strings, and they may be features of shapes such as the number of sides of characters. In that case, the features of shapes may be stored in the character string storage area in FIG. 3.

Further, when the results of telop recognition are converted to those other than character strings, such as features of shapes, the keyword position data generating unit 209 may be adapted to have a structure such that a keyword appearing position is searched by use of features of shapes or the like other than the character string. This will be described later when reference is made to the keyword position data generating unit 209.

FIG. 3 is a diagram showing an example of a data structure of an indexing data.

Numeral 301 represents a number for a speech such as line or dialogue spoken at a certain time or a number for a character string displayed at a certain time, numeral 304 represents a speech, such as line or dialogue pronounced or a character string displayed. As for the pronounced line or dialogue, when caption information is employed, the pronounced line or dialogue may be a character string as a result of the decoding of the caption information. When speech recognition is performed, the line or dialogue may be a character string as a result of the speech recognition of sound per unit time, or may be phoneme data, while when telop recognition is performed, the telop may be a character string as a result of the telop recognition at the time of recognition of appearance of a telop or may be data representative of features of shapes such as the number of sides or the number of writing strokes.

Numeral 302 represents a number of bytes of a character string stored in the area 304 or an amount of data such as phoneme data stored in the area 304, and specifically, the amount of the data may be in the form of a number of bytes.

Numeral 303 represents a time at which the data stored in the area 304 is actually outputted, that is, a time at which line or dialogue data stored in the area 304 is pronounced or character data stored in the area 304 is displayed. Such time may, when caption information is used, be a time as a result of decoding. When speech recognition is performed and the recognition is achieved of sound per a unit time, the time to be stored in the area 303 may be a time at which the sound is outputted, while when telop recognition is performed, the time to be stored in the area 303 may be a time at which a telop is displayed. The indexing data generating unit 202 generates entries each including the above-mentioned data 301 to 304. In FIG. 3, the indexing data is shown as having three entries 311 to 313.

The indexing data generating unit 202 stores zero for all of the data areas as shown at 314 when no entry exists. Thereby, the indexing data input unit 204 (to be described later), when reading the indexing data, is allowed to know an end of entry.

In FIG. 3, the respective area sizes are shown, as an example, such that the data number area 301 has a size of 4 bytes, the number of bytes area 302 has a size of 4 bytes, the time area 303 has a size of 8 bytes, and the character string area 304 has a size of N bytes. However, the respective area sizes are not restricted to the above, and they should be determined so as to be sufficient for storing the respective data for a movie contents data.

Turning back to FIG. 2, the indexing data holding unit 203 holds indexing data generated at the indexing data generating unit 202. This is accomplished, for example, by storing the indexing data generated at the indexing data generating unit 202 in the storage device 105 or in the secondary storage device 106.

The indexing data input unit 204 inputs indexing data held in the indexing data holding unit 203 or indexing data generated in advance in another apparatus. This is accomplished, for example, by reading indexing data stored in the storage device 105 or in the secondary storage device 106. Alternatively, when indexing data already generated by another apparatus is inputted, access should be had to such apparatus as storing the indexing data under consideration through the network data input device 108 thereby to obtain the indexing data. To this end, since known measures for obtaining network data are applicable, description thereon will be omitted here.

The keyword data generating unit 205 analyzes a character string in the indexing data inputted by the indexing data input unit 204 and decomposes it into words to generate a keyword data as shown in FIG. 4. It is noted that the dictionary unit 220 and/or techniques for the morphological analysis may be applied to the analysis of character strings and the generation of keywords. Further, since known technique is applicable to the morphological analysis, description thereon will be omitted here.

In the analysis of a character string in the indexing data, by removing from the character string those parts which serve as spaces and ruby (ruby annotation) and control codes for designating the character color and the display position, it is possible to enhance the precision of the analysis. When the indexing data is generated from the caption data, removal of space parts can be realized by deleting character code for the space from the caption data, and the removal of ruby parts can be realized by determining control codes for the character size and deleting from the caption data those character strings which are to be displayed in a ruby size.

Turning back to FIG. 2, the dictionary unit 220 may, for example, include a biographic dictionary or a dictionary for a fixed keyword for each program or for each program category (the program and program category being collectively referred to as “the category of movie contents data”) such as “weather forecast” or “home run”, thereby to alleviate problems such that too many keywords are extracted so that they cannot be displayed in a table or a user cannot specify a keyword easily. Further, the dictionaries may be arranged so that they are alternatively used depending on the category of movie contents data. The category of movie contents data may be decided, for example, by a metadata attached to a program, an EPG (Electronic Programming Guide) data, or user's designation.

Further, when use is made of a dictionary of keywords pronounced at the head of or in the introduction of a topic (i.e., at changes between topics) such as “next”, “in the next place” or “in the following”, by picking up such words, it will be possible to detect the changes between topics in a movie contents data.

The generated keywords can be indicated at the keyword showing unit 212.

FIG. 4 is a diagram showing an example of a data structure of a keyword data.

Numeral 403 represents a character string itself serving as a keyword which is generated through analysis of and decomposition into words of the character string in the indexing data by the keyword data generating unit 205. Specifically, the character string 403 may be a portion of the character string in the indexing data. For example, as described above, it may be a character string (a keyword) of a noun word extracted from the character string in the indexing data by use of the dictionary unit 220 and/or the technique such as the morpheme analysis.

Numeral 401 represents a number for keyword, and numeral 402 a number of bytes of a character string serving as a keyword. The keyword generating unit 205 may take the statistics of keywords inputted by a user at the keyword input unit 208 (to be described later) to give a score to each keyword depending on the results of the statistics, for example, according to the number of times it has been so far designated by the user. In that case, in FIG. 4, a score 404 is given to each keyword and entry 401 to 404 can be formed. In FIG. 4, three entries 411 to 413 are shown as an example. The keyword generating unit 205 should store zero for all of the data areas as shown at 414 when no entry exists. Thereby, the keyword data input unit 207 (to be described later), when reading the keyword data, is allowed to know an end of entry of the keyword data.

In FIG. 4, the respective area sizes are shown, as an example, such that the keyword number area 401 has a size of 4 bytes, the number of bytes area 402 has a size of 4 bytes, the keyword character string area 403 has a size of N bytes, and the score area 404 has a size of 4 bytes. However, the respective area sizes are not restricted to the above, and they should be determined so as to be sufficient for the respective data lengths.

Turning back to FIG. 2, the keyword data holding unit 206 holds keyword data generated at the keyword data generating unit 205. This is accomplished, for example, by storing the keyword data generated at the keyword data generating unit 205 in the storage device 105 or in the secondary storage device 106.

The keyword input unit 207 inputs a keyword data held in the keyword data holding unit 206 or a keyword data already generated by another apparatus. This is accomplished, for example, by reading a keyword data stored in the storage device 105 or in the secondary storage device 106. Alternatively, when a keyword already generated by another apparatus is inputted, access should be had to such apparatus as storing the keyword data under consideration through the network data input device 108 thereby to obtain the keyword data. To this end, since known measures for obtaining network data are applicable, description thereon will be omitted here.

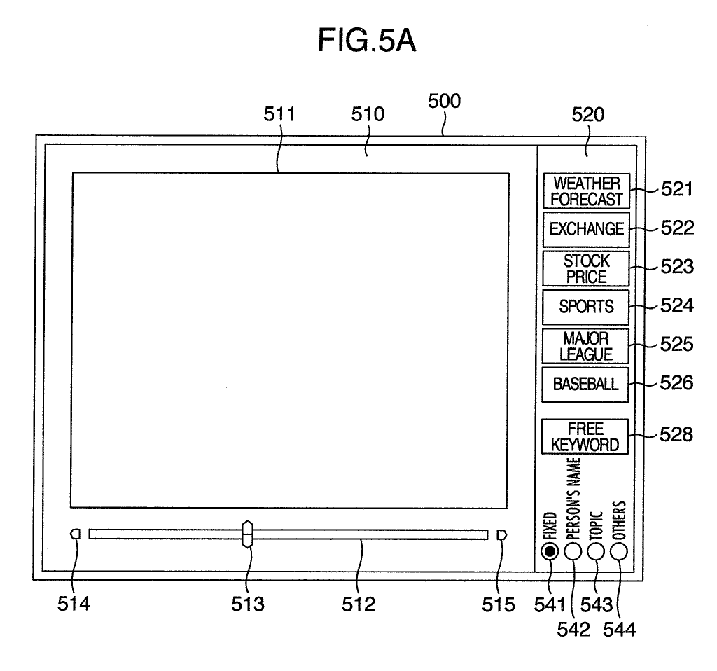

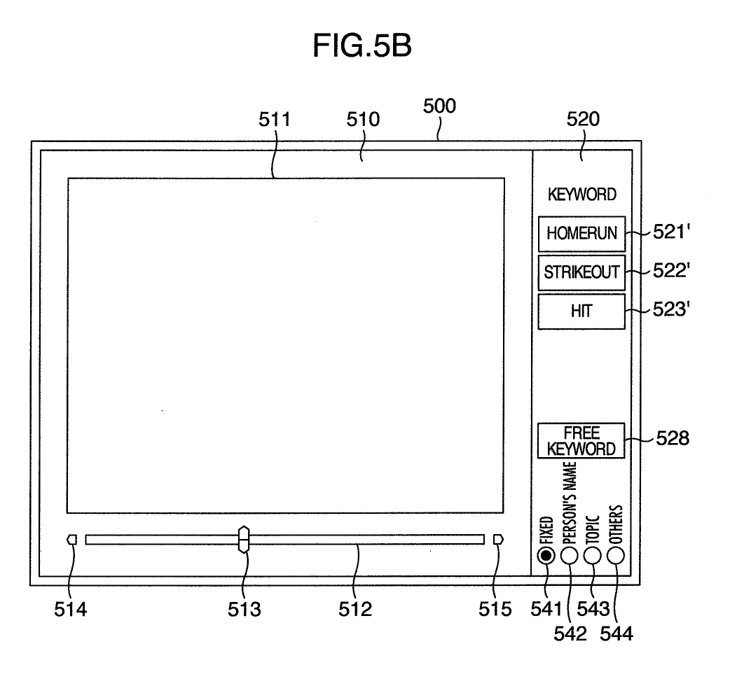

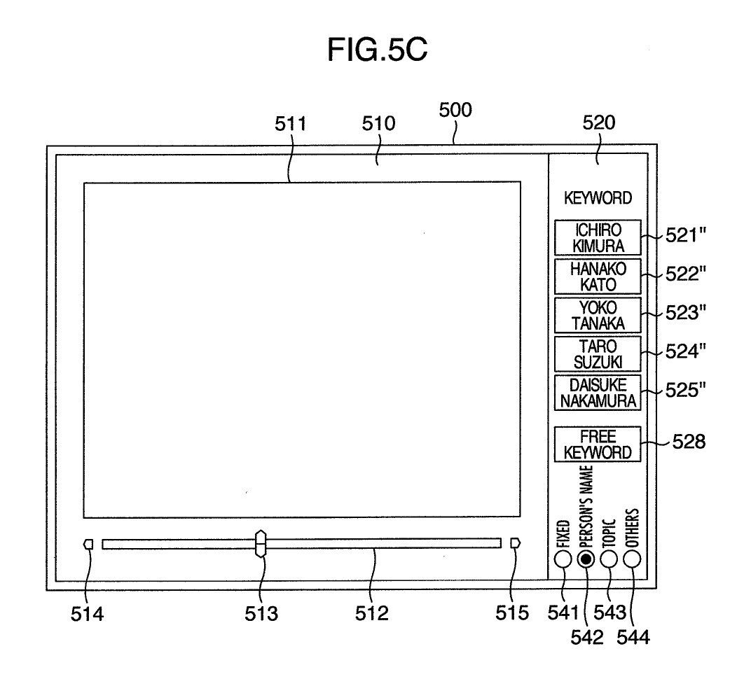

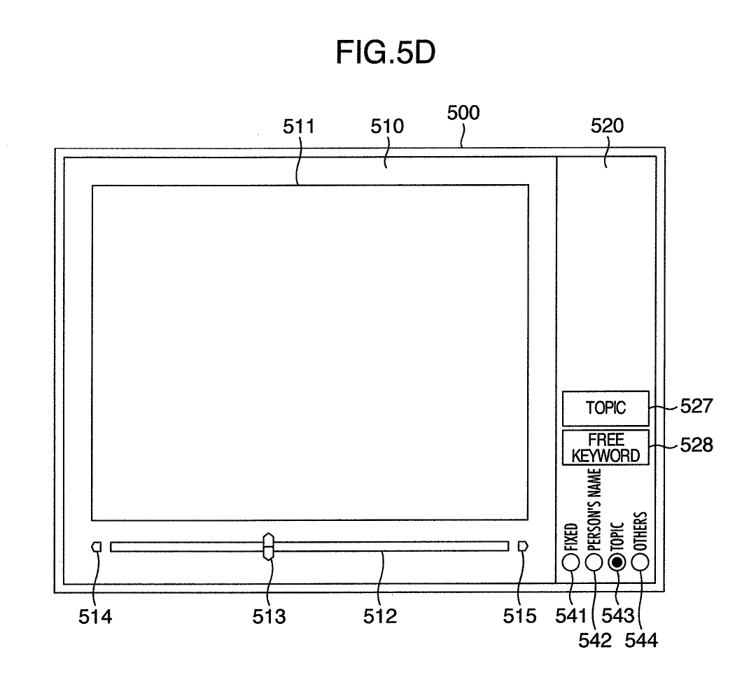

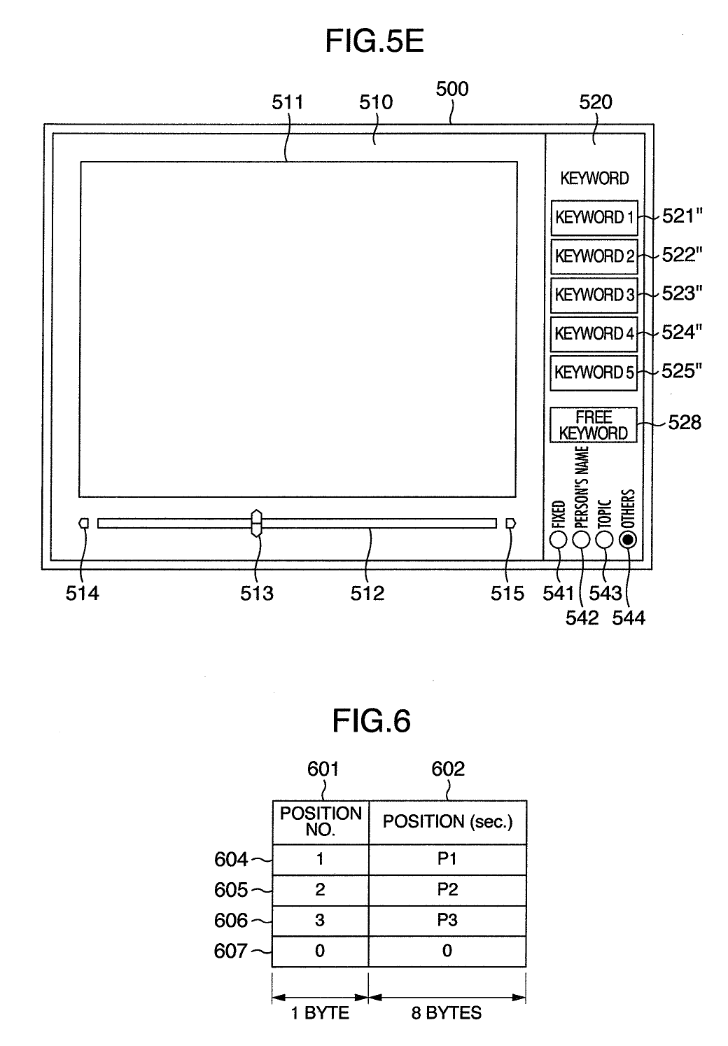

The keyword indicating unit 212 indicates, as shown in FIGS. 5A to 5E, to a user keywords stored in the keyword data inputted at the keyword data input unit 207.

FIG. 5A is a diagram of an example of a display screen in the player for movie contents which contains keywords indicated to the user particularly with respect to a news program, as an example.

Numeral 500 represents a display screen on the displaying device 103, numeral 510 a movie contents manipulation window, and numeral 511 a movie contents display window. A movie contents data to be played back is displayed on the movie contents display window 511.

Numerals 512 and 513 represent a playing position indicator, by which a user is able to recognize, change or designate the playing position.

Numerals 514 and 515 represent playing position designating buttons. When the user presses the button 514 or 515, the playing position designating unit 219 (to be described later) will change the playing position.

Numeral 520 represents a keyword display window. The keyword indicating unit 212 displays on the keyword window 520 keywords stored in the keyword data thereby to indicate to the user key words contained in a movie contents data. In FIG. 5a, numerals 521 to 526 represent keywords, which may be represented by buttons. Thus, when the user presses one of the buttons for the displayed keywords, the keyword input unit 208 (to be described later) acts to designate and input a keyword.

Numerals 541, 542, 543 and 544 represent buttons for designating, for each program or for each program category, an indication of fixed keywords, keywords for persons' names, keywords for topics or keywords for others. The arrangement is such that, by manipulation of these buttons, the dictionary unit 220 to be used in the keyword data generating unit 205 is specified, for each program or for each program category, as having a dictionary for fixed keywords, a dictionary for persons' names, a dictionary for keywords pronounced at the heads of topics or a dictionary for keywords designated by the user. Particularly, when the button 541 is pressed, a program or a program category is obtained from an EPG and the dictionary for fixed keywords for each program or for each program category is used. Thereby, keywords or a kind desired by a user can be indicated.

FIG. 5A shows an example in which fixed keywords are indicated for a news program, while FIG. 5B shows another example in which fixed keywords are indicated for a baseball program. FIG. 5C shows another example in which keywords for persons' names are indicated, while FIG. 5D shows another example in which it is possible to search heads of topics. In FIG. 5D, the arrangement is such that when the user presses the topic button 527, the keyword position data generating unit 209 (to be described later) retrieves all or a portion of the character strings entered in the keyword data. Thereby, it is possible to view movie contents data for each topic. FIG. 5E shows another example in which keywords for persons' names are indicated.

In each of FIGS. 5A to 5E, a free keyword 528 is provided so that the user designates a keyword. When the user presses the free keyword 528, a keyword input window 531 as shown in FIG. 14 is displayed so that the user is allowed to designate a keyword at a keyword input box 532. In that case, the arrangement is such that when the user inputs a keyword to the keyword input box 532 through the input device 102 and presses an OK button 533, the keyword position data generating unit 209 (to be described later) retrieves the keyword inputted to the keyword input box 532. In that arrangement, when the user presses a CANCEL button 534, the keyword inputted to the keyword input box 532 is made invalid so that the keyword position data generating unit 209 no longer retrieves the keyword inputted to the keyword input box 532.

Further, the indication of keywords by the keyword showing unit 212 may be such that keywords having a predetermined score are indicated to the user or a predetermined number of keywords are selected among the keywords having high scores and displayed to the user. Alternatively, the display of keywords by the keyword showing unit 212 may be such that keywords having a score designated by the user are shown to the user or that number of keywords which is designated by the user, are selected among the keywords having high scores and displayed to the user.

Turning back to FIG. 2, the keyword input unit 208 inputs a keyword designated by a user. In any one of the display screens shown in FIGS. 5A to 5E, this is accomplished, for example, by obtaining a keyword, which is selected by the user among the keywords indicated in the keyword display window 520 by the keyword showing unit 212. Particularly, when keywords are displayed on the respective buttons as described above, the keyword input by the user may be accomplished by obtaining the character string displayed on the button which the user pressed.

Incidentally, the inputted keyword may be adapted so as to be supplied to the keyword generating unit 205, as described above. In that case, the keyword generating unit 205 may have a structure such that the unit 205 takes the statistics of keywords inputted by a user at the keyword input unit 208 to give a score to each keyword depending on results of the statistics, for example, according to how many times it has been so far designated by the user. Upon designation by the user of a keyword at the keyword input unit 208, the present movie contents player searches the position at which the keyword appears in a movie contents data and starts reproducing. Thereby, the user is allowed to view a scene in which a desired keyword appears.

The keyword position data generating unit 209 generates, based on a character string of a keyword inputted at the keyword input unit 208 and an indexing data inputted at the indexing data input unit 204, a keyword position data as shown in FIG. 6. To this end, the keyword position data generating unit 209 retrieves the character string of the keyword inputted at the keyword input unit 208 in the character strings of the respective entries in the indexing data inputted at the indexing data input unit 204 to obtain a time 303 in that entry in the indexing data (FIG. 3) in which the inputted keyword is found, and the thus obtained data on the time is stored in a position area 602 in the keyword position data shown in FIG. 6.

As described above, when the indexing data generating unit 202 stores in the character string area 304 features of phoneme or features of shapes or the like, which are information other than the character strings, obtained through the speech recognition or telop recognition, the keyword position data generating unit 209 converts the information, based on character strings of the keyword inputted by the keyword input unit 208, to features of phoneme or features of shapes or the like and retrieves the features of phoneme or features of shapes in the entries of the indexing data thereby to obtain a time 303 in that entry of the indexing data which matches the features of phoneme or features of shapes corresponding to the character string of the inputted keyword. The thus obtained time data is stored in the position data area 602 in the keyword position data shown in FIG. 6.

FIG. 6 is a diagram showing an example of a data structure of a keyword position data.

Numeral 601 represents a number for position and numeral 602 represents a position at which a character string appears, which character string is a character string of a keyword inputted by the keyword input unit 208 and having been found. The data to be stored in the position data area 602 may be a data representative of time at which the character string under consideration is displayed in a movie contents data. In FIG. 6, it is assumed that the position in movie contents is designated by means of a time at which a character string appears in a movie contents data. Thus, when a character string of a keyword inputted by the keyword input unit 208 is found in the characters 304 of the indexing data (FIG. 3) inputted by the indexing data input unit 204, times 303 in corresponding entries in the indexing data are stored in the position data area 602.

Alternatively, when features of phoneme or shapes and features of characters corresponding to a character string of a keyword inputted by the keyword input unit 208 are found in the character strings 304 in the indexing data (FIG. 3) inputted by the indexing data input unit 204, times 303 in corresponding entries in the indexing data may be stored in the position data area 602.

In FIG. 6, it is shown as an example, that a character string or features of phoneme or features of character shapes inputted by the keyword input unit 208 is (are) found in the character strings of three of the entries inputted by the indexing data input unit 204. Such character strings are stored in the three entries 604 to 606 as shown. The keyword position data generating unit 209 should store zero for all of the data areas of a last entry as shown at 607. Thereby, when the keyword position data input unit 211 (to be described later) reads this keyword position data, the unit 211 is allowed to know the end of entry.

In FIG. 6, the respective area sizes are shown, as an example, such that the position number area 601 has a size of 4 bytes and the position area 602 has a size of 8 bytes. However, the respective area sizes are not restricted to the above, and they should be determined so as to be sufficient for the respective data lengths.

Turning back to FIG. 2, the keyword position data holding unit 210 holds keyword position data generated at the keyword position data generating unit 209. This is accomplished, for example, by storing the keyword position data generated at the keyword position data generating unit 209 in the storage device 105 or in the secondary storage device 106.

The keyword position data input unit 211 inputs keyword position data held in the keyword position data holding unit 210 or keyword position data already generated by another apparatus. This is accomplished, for example, by reading the keyword position data stored in the storage device 105 or in the secondary storage device 106. Alternatively, when a keyword position data already generated by another apparatus is inputted, access should be had to such apparatus as storing the keyword position data under consideration through the network data input device 108 thereby to obtain the keyword position data. To this end, since known measures for obtaining network data are applicable, description thereon will be omitted here.

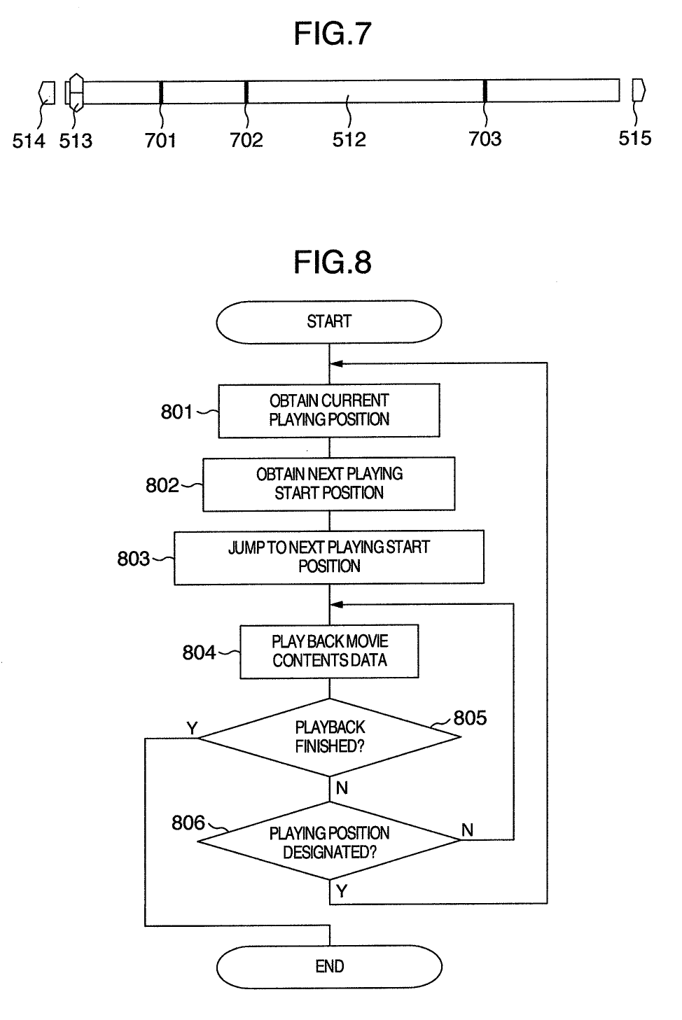

The keyword position showing unit 213 indicates, based on a keyword position data inputted at the keyword position data input unit 211, a position at which a keyword designated by a user appears in a movie contents data. This is accomplished, for example, as shown in FIG. 7, by making a mark at a position, which corresponds to the position 602 of the entry in the keyword position data (FIG. 6), on the displaying position indicator 512 as described with reference to FIG. 5.

FIG. 7 is a diagram showing an example of an indication of a keyword position. In FIG. 7, numerals 512 and 513 represent a playing position indicator which is also described above with reference to FIG. 5. Numerals 514 and 515 represent playing position designating buttons which are also described above with reference to FIG. 5. The keyword positions indicated by the keyword indicating unit 213 are represented by numerals 701 to 703. Practically, the indication is accomplished by making marks at positions, which correspond to the positions of the entries in the keyword position data, on the playing position indicator 512. More specifically, it is introduced that the playback time length of the whole movie contents data corresponds to the length of the playing position indicator 512 and the left-hand side end of the indicator 512 corresponds to time 0 (zero). Then, a position on the indicator 512 corresponding to a time stored in the position data 602 in the keyword position data is determined from the length of the playing position indicator 512 and a ratio of the time stored in the position data 602 to a time length of playback of the whole of a movie contents data and a mark is made at the thus determined position on the indicator 512.

Turning back to FIG. 2, the to-be-played-back movie contents data input unit 215 inputs a movie contents data to be played back from the movie contents data input device 100.

The displaying unit 218 displays a played-back video at the playback control unit 214 (to be described later) on the displaying device 103.

The sound output unit 217 outputs a played-back sound at the playback control unit 214 (to be described later) to the sound output device 104.

The playing position designating unit 219, when a user changes the playing position, informs the playback control unit 214 thereof. This is accomplished, for example, as follows: when the playing position designating button 514 or 515 as shown in FIGS. 5A to 5E and FIG. 7 is pressed by the user, this fact is informed to the playback control unit 214 (to be described later) by means of an event or a flag.

The playback control unit 214 inputs a movie contents data from the to-be-played-back movie contents input unit 215 and generates played-back videos and played-back sound for supply to the displaying unit 218 and the sound output unit 217, respectively, thereby playing back the movie contents data. An example of processing by the playback control unit 214 is shown in FIG. 8.

FIG. 8 is a flowchart illustrating an example of processing in the playback control unit 214.

As shown in FIG. 8, the playback control unit 214 first obtains the current playing position in a movie contents data (time in the movie contents data) (step 801), and then, obtains, based on the current playing position, a next playing start position (step 802). This can be accomplished by obtaining a position which is after the current playing position and the nearest thereto by reference to the position 602 in the keyword position data (FIG. 6).

Next, the processing jumps to the next playing start position obtained at step 802 (step 803) and plays back a movie contents data from the playing start position (step 804). This is accomplished by displaying, on the displaying device 103 through the displaying unit 218, played-back pictures in the movie contents data from the playing start position, and by outputting, to the sound output device 104 through the sound output device 104, played-back sound in the movie contents data from the playing start position.

During the playback of the movie contents data, it is regularly judged whether or not the playback is finished (step 805), and if the playback is finished, the playback of the movie contents data is ended. Practically, when the whole of the movie contents has been played back or when a user designates a termination of the playback, it is judged that the playback is finished.

Further, during the playback of the movie contents data, it is regularly judged whether or not the playing position designation unit 219 designates a change in the playing position (step 806). If this judgement in step 806 results in a decision such that the playing position designation unit 219 does not designate a change in the playing position, the processing returns back to step 804 so that steps 804 to 806 are repeated for continuation of playback of the movie contents data.

On the other hand, if the judgement in step 806 results in a decision such that the playing position designation unit 219 designate a change in the playing position, the processing returns back to step 801 so that steps 801 to 806 are repeated for playback of the movie contents data from the next playing start position determined by the designated change in the playing position.

When the user presses the playing position designating button 515 through the playing position designating unit 219, the processing obtains, in step 802, a position which is after the current playing position and is the nearest thereto, by reference to the position 602 in the keyword position data (FIG. 6).

When the user presses the playing position designating button 514 through the playing position designating unit 219, the processing obtains, in step 802, a position which is before the current playing position and is the nearest thereto, by reference to the position 602 in the keyword position data (FIG. 6).

Consequently, when the playing position designating button 515 is pressed by the user, playback of the movie contents data will be started from the position of the following keyword appearance with respect to time, while when the playing position designating button 514 is pressed by the user, playback of the movie contents data will be started from the position of the preceding keyword appearance with respect to time.

By the above-described processing, it is possible to play back a movie contents data from a position at which a keyword designated by a user appears.

### (3) Overall Control

The overall operation of the present player for movie contents data will now be described with respect to a movie contents data recording mode and a movie contents data playback mode.

First, an operation of recording a movie contents data will be described. When the present movie contents player does not perform a movie contents recording, the following operation will not be necessary.

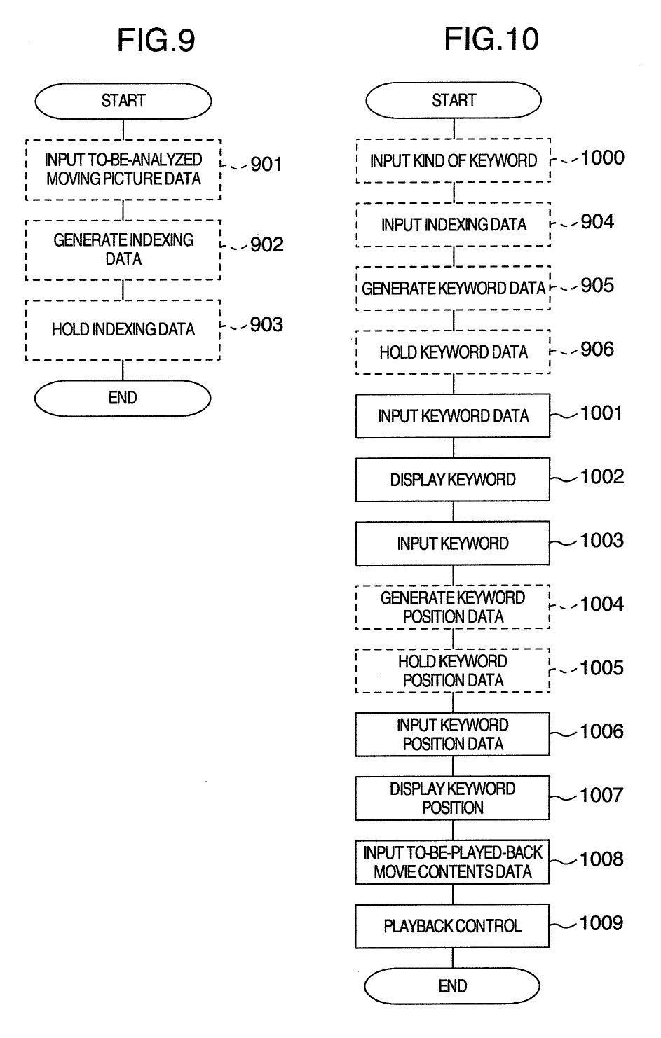

FIG. 9 is a flowchart illustrating an example of an operation of the present movie contents player in which a movie contents data is recorded.

As shown in FIG. 9, the present movie contents player in a movie contents data recording operation first inputs, through the to-be-analyzed movie contents data input unit 202, a movie contents data to be recorded (step 901), generates an indexing data through the indexing data generating unit 202 (step 902), holds, through the indexing data holding unit 203, the indexing data generated through the indexing data generating unit 202 at step 902 (step 903), and ends a recording operation. When no indexing data is generated in the present movie contents player as in a case in which use is made of an indexing data already generated by another apparatus, step 902 will be unnecessary. Needless to say, not only an indexing data but also a movie contents data should be recorded.

Next, an operation of the present movie contents player playing back a movie contents data will be described.

FIG. 10 is a flowchart illustrating an example of an operation of the present movie contents player in which a movie contents data is played back.

As shown in FIG. 10, the present movie contents player in a movie contents data playback operation first inputs a kind of keywords to be indicated (to be shown in a list) (step 1000). This is accomplished, for example, by a user inputting a kind of keywords by means of the buttons 541 to 544 shown in FIGS. 5a to 5e.

Subsequently, the present player inputs, through the indexing data input unit 204, indexing data for a movie contents data to be played back (step 904), generates, through the keyword data generating unit 205, keyword data contained in the to-be-played-back movie contents data (step 905), and holds, through the keyword data holding unit 206, the keyword data generated through the keyword data generating unit 205 in step 905 (step 906). When the present player does not generate keyword data as in a case in which use is made of keyword data already generated by another apparatus, steps 904, 905 and 906 will not be necessary.

In playing back a movie contents data, the present movie contents player now inputs, through the keyword data input unit 207, keyword data describing those keywords which are contained in the to-be-played-back movie contents data (step 1001) and displays or shows, through the keyword showing unit 212, the keywords in the keyword data, namely, those which are contained in the to-be-played-back movie contents data (step 1002).

Next, the keyword input unit 208 inputs a keyword for a scene which a user wants to view (step 1003). For example, in the example of the display screen shown in FIG. 5A, one of the square shapes 521 to 526 is selected, or alternatively, with the square shape 528 being selected, characters for a keyword are inputted on a display window as shown in FIG. 14.

The keyword position data generating unit 209 generates data on the position at which the keyword inputted in step 1003 by the keyword input unit 208 appears in the to-be-played-back movie contents data (step 1004), and the keyword position data holding unit 210 holds the keyword position data generated in step 1004 by the keyword position data generating unit 209 (step 1005). When the present player does not generate keyword position data as in a case in which use is made of keyword position data already generated by another apparatus, steps 1004 and 1005 will not be necessary.

Next, the present movie contents player inputs a keyword position data through the keyword position data input unit 211 (step 1006), and shows or displays, through the keyword position showing unit 213, a position in the movie contents data described in the keyword position data, that is, a position at which the keyword designated by the user appears (step 1007).

Thereafter, the present movie contents player inputs a to-be-played-back movie contents data through the to-be-played-back data picture input unit 215 (step 1008). And, through the playback control unit 214, the movie contents player displays, on the displaying device 103 via the displaying unit 218, played-back pictures as of the position of appearance of the keyword in the to-be-played-back movie contents data designated by the user, and supplies, to the sound output device 104 through the sound output unit 217, played-back sound as of the position of appearance of the keyword, whereby the to-be-played-back movie contents data is played-back (step 1009).

FIGS. 9 and 10 show examples of the timing of generation of the indexing data and those of generation of the keyword data and the keyword position data, respectively, and therefore, it is optional whether such data are generated in the recording operation mode or in the playback operation mode. Likewise, FIGS. 3, 4 and 6 teach an example of demarcation among the indexing data, the keyword data and the keyword position data, and therefore, the manner of demarcation is optional: for example, all of the data shown in FIGS. 3, 4 and 6 may be merged into one data structure. Further, the three data may be generally termed a keyword data.

As has been described above, it is possible for a user to designate a keyword for a desirable scene and play back a movie contents data as of the desirable scene in which the designated keyword appears. In addition, it is possible for a user to confirm keywords contained in a movie contents data prior to playback of the movie contents data and to determine whether or not a desirable scene is contained in a movie contents data prior to playback of the movie contents data or at a time as soon as possible.

### Embodiment 2

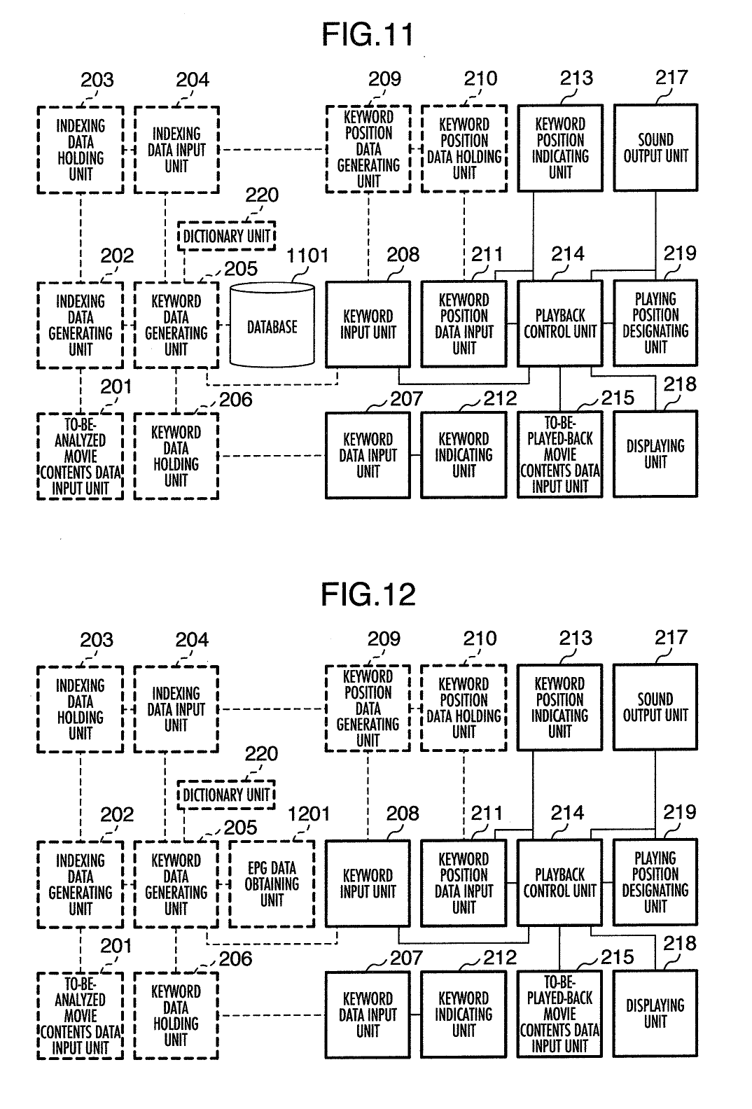

FIG. 11 is a block diagram of an example of function blocks of a player for movie contents according to Embodiment 2.

In the movie contents data player shown in FIG. 11, a database 1101 is added to the structure shown in FIG. 2. Keywords such as for persons' names and names of places are entered in advance in the database 1101. The keyword data generating unit 205 analyzes the character string in the indexing data inputted by the indexing data input unit 204 and decomposes it into words and generates, when a keyword entered in the database 1101 appears, a keyword data on the basis of the keyword.

In the structure shown in FIG. 11, it is possible to indicate to a user only keywords that are entered in advance and to play back a movie contents data as of the scene for a keyword entered in advance. As for the structure and the processing other than those described above in connection with Embodiment 2, they may be similar to Embodiment 1.

### Embodiment 3

FIG. 12 is a block diagram of an example of function blocks of a player for movie contents according to Embodiment 3.

In the movie contents data player shown in FIG. 12, an EPG (Electronic Programming Guide) data obtaining unit 1201 is added to the structure shown in FIG. 2.

The EPG data obtaining unit 1201 obtains an EPG data for a to-be-analyzed movie contents data. An EPG data corresponding to a to-be-analyzed movie contents data can be obtained, for example, from a broadcast by the to-be-analyzed movie contents data input unit 201. Alternatively, the arrangement may be such that an EPG data is obtained by a predetermined apparatus through the network data input device 108.

The keyword data generating unit 205 analyzes an EPG data obtained at the EPG data obtaining unit 1201 and decomposes it into words and also analyzes a character string and decomposes it into words in the indexing data inputted by the indexing data input unit 204. When results of the analysis and decomposition of the EPG data are contained in the character string in that indexing data, the keyword data generating unit 205 generates a keyword data with a character string obtained from the results of the analysis and decomposition being used as a keyword.

In the structure shown in FIG. 12, it is possible for a user to confirm EPG data and plays back a movie contents data as of a scene for a keyword contained in the EPG data. As for the structure and the processing other than those described above in connection with Embodiment 3, they may be similar to Embodiment 1.

### Embodiment 4

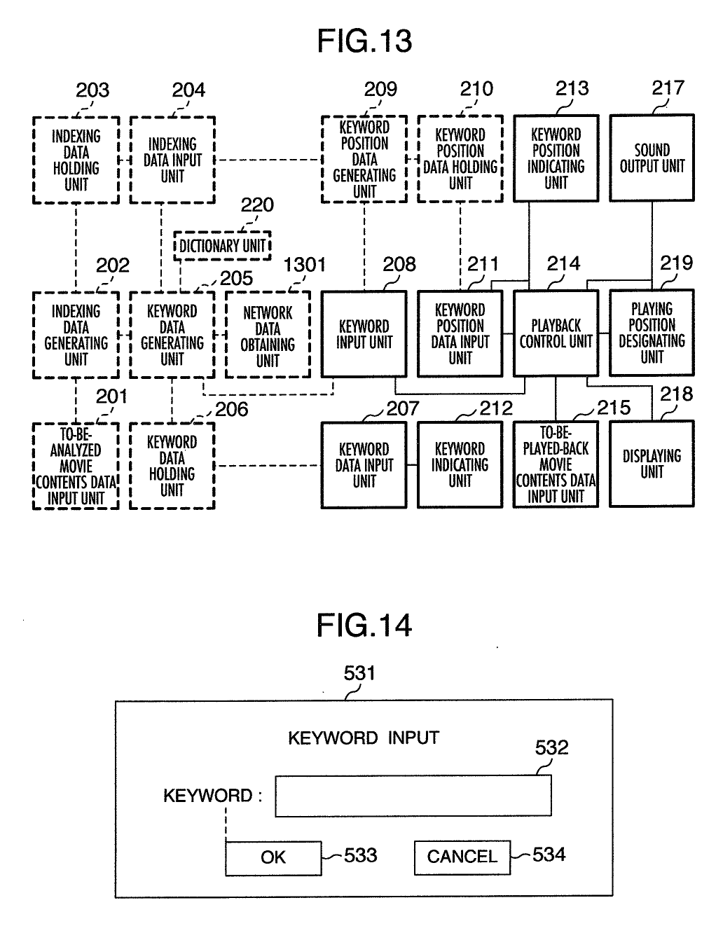

FIG. 13 is a block diagram of an example of function blocks of a player for movie contents according to Embodiment 4.

In the movie contents data player shown in FIG. 13, a network data obtaining unit 1301 is added to the structure shown in FIG. 2.

The network data obtaining unit 1301 obtains information such as on names of performers and corners related to a to-be-analyzed movie contents data. This may be accomplished by arranging the player such that the above information is obtained from an apparatus on a network, which provides information on the to-be-analyzed movie contents data, through the network data input unit 108, or may be accomplished by searching for a site which provides such information and accessing the site to obtain the information.

The keyword data generating unit 205 analyzes the information obtained at the network data obtaining unit 1301 and decomposes it into words and also analyzes a character string in the indexing data inputted by the indexing data input unit 204 and decompose it into words. When results of the analysis and decomposition of the information obtained at the network data obtaining unit 1301, in the character string in that indexing data are composed or contained, the keyword data generating unit 205 generates a keyword data with a character string obtained from the results of the analysis and decomposition being used as a keyword.

In the structure shown in FIG. 13, it is possible to obtain a keyword from a network, even when the EPG data is insufficient, the speech recognition or telop recognition is not satisfactory, or provision of information by the telop or caption is not satisfactory. As for the structure and the processing other than those described above in connection with Embodiment 4, they may be similar to Embodiment 1.

The present invention has been described above with reference to Embodiments 1 to 4. The movie contents player may be realized by use of any combination of the teachings or techniques or techniques of these embodiments.

Further, in these embodiments, for generation of the index data and the keyword position data, use is made of the measures employing the caption information, telop recognition and speech recognition. However, the measures to be used are not restricted thereto, and any other measures for obtaining information such as the visage recognition may be employed that allows indexing of a movie contents data and search of a position of keyword appearance. When such information is used, the priority order may be given thereto. For example, when caption information is provided, it will be preferentially utilized, and in the absence of caption information, information from the telop recognition will be utilized, and when both caption information and telop information are not available, information from the speech recognition will be utilized. In this way, by the introduction of the priority order, even when the recognition results are not satisfactory or information being provided is little or insufficient, it is possible to generate the indexing data and the keyword position data.

Additionally, as for the generation of the keyword data, in the described embodiments, measures are taken for employing caption information, telop recognition, speech recognition, database, EPG data and network data. However, the measures to be used are not restricted thereto, and any other measures for obtaining information such as the visage recognition may be employed that allows generation of keywords for a movie contents data. When such information is used, the priority order may be given thereto. For example, when a database is available, it will be preferentially utilized, and in the absence of a database, network information will be utilized, and when both a database and network information are not available, caption information will be utilized. If caption information is not available, either, an EPG data will be utilized. If an EPG data is not available, either, information from the telop recognition will be utilized. If information from the telop recognition is not available, either, information from the speech recognition will be utilized. Thereby, even when the recognition results are not satisfactory or information being provided is little or insufficient, it is possible to generate the keyword data.

It should be further understood by those skilled in the art that although the foregoing description has been made on embodiments of the invention, the invention is not limited thereto and various changes and modifications may be made without departing from the spirit of the invention and the scope of the appended claims.

1. A player for movie contents data comprising:
a keyword displaying unit for displaying, on a plurality of display windows, a plurality of keywords corresponding to a movie contents data;
a selection input receiving unit for receiving a selection input for selecting a first keyword among said plurality of keywords displayed by the keyword displaying unit; and
a scene playback unit for playing back one or more scenes corresponding to said first keyword.

2. A player according to claim 1, further comprising a position displaying unit for displaying a position or a time, in said movie contents data, of said one or more scenes corresponding to said first keyword.

3. A player according to claim 1, further comprising a position displaying unit for displaying a position or a time, in said movie contents data, of said one or more scenes corresponding to said first keyword, wherein said displayed position or time is related to said first keyword.

4. A player according to claim 2, further comprising a playing position designating unit for receiving a selection input of an optional position or time among times or positions of a plurality of scenes displayed by said position displaying unit.

5. A player according to claim 1, further comprising a keyword data generating/input unit for generating or inputting a keyword data including said plurality of keywords.

6. A player according to claim 5, further comprising an indexing data generating unit for generating an indexing data, on the basis of a speech pronounced in the movie contents data or a character string displayed therein and of a time at which said speech is pronounced or at which said character string is displayed.

7. A player according to claim 5, wherein said keyword data generating/input unit generates said keyword data on the basis of a caption data.

8. A player according to claim 6, wherein said keyword data generating/input unit generates said keyword data from a caption data from which information representative of spaces or ruby or a character color has been removed.

9. A player according to claim 5, wherein said keyword data generating/input unit generates said keyword data on the basis of speech recognition.

10. A player according to claim 5, wherein said keyword data generating/input unit generates said keyword data on the basis of telop recognition.

11. A player according to claim 5, wherein said keyword data generating/input unit generates said keyword data on the basis of an EPG data.

12. A player according to claim 5, wherein said keyword data generating/input unit generates said keyword data on the basis of a data obtained via a network.

13. A player according to claim 1, wherein said plurality of keywords consist of persons' names.

14. A player according to claim 1, wherein said plurality of keywords are determined on the basis of a category of said movie contents data.

15. A player according to claim 1, wherein said plurality of keywords consist of a word representative of a change between topics.
